(19) United States
(12) Patent Application Publication
(10) Pub. No.: US 2026/0063291 A1
(43) Pub. Date: Mar. 5, 2026

(54) SINGLE LAYER PORTABLE DANCE FLOOR

(71) Applicant: Hard Chill LLC, Brooklyn, NY (US)

(72) Inventors: Carl Weber, Brooklyn, NY (US); Joseph Louis Belverio, JR., Fairfield, NJ (US)

(21) Appl. No.: 19/385,982

(22) Filed: Nov. 11, 2025

Related U.S. Application Data
(63) Continuation-in-part of application No. 18/892,334, filed on Sep. 20, 2024, now Pat. No. 12,467,266.
(60) Provisional application No. 63/539,556, filed on Sep. 20, 2023.

(51) Int. Cl. F21V 33/00; E04F 15/02

(52) U.S. Cl. CPC F21V 33/006; E04F 15/02005; E04F 15/02172; E04F 2201/05; E04F 2290/026

(57) ABSTRACT

The present disclosure relates to single layer portable dance floors comprising, in various embodiments, one or more removably couplable panels that can be used alone or assembled and disassembled in modular configurations, including or one or more panels that can be connected with an electrical cord, a fastener, or a living hinge. The panels can comprise lightweight and durable materials that can be flexible or rigid, such that the portable dance floors that are light and durable and can be easily stored, transported, and assembled or disassembled and dismantled by a single user or a low number of users, and do not require additional securing mechanisms such as adhesives or underlayments to function as dance floors. The present disclosure also relates to methods of assembling and disassembling or dismantling a portable dance floor.

### CROSS-REFERENCE TO RELATED APPLICATIONS

The present application is a continuation-in-part application of U.S. Application No. 18/892,334 filed September 20, 2024, which claims the benefit of U.S. Provisional Application No. 63/539,556 filed September 20, 2023, the contents of which are incorporated by reference in their entireties.

### BACKGROUND

The present disclosure relates to exemplary embodiments of a portable dance floor, such as a portable modular dance floor, which has the advantages of easy assembly, disassembly or dismantling, and easy transport from one location to another; as well as to methods of assembling and disassembling such a floor.

Dance floors disclosed in the prior art, especially dance floors incorporating a lighting element, are generally comprised of rigid materials to withstand continuous impact and protect the lighting element and circuitry within the dance floor. As a result, such dance floors are heavy, typically weighing between 500 and 1,000 pounds, and take up a large amount of space when stored. This presents significant challenges to purveyors of such dance floors when transporting, assembling, disassembling, and storing the dance floor. Frequently, a large team of workers, using a significant number of tools, is required to transport, assemble, and dismantle such dance floors. This can greatly increase labor and transportation costs, risk of injury, and inconvenience and delay.

An ongoing need exists for a portable dance floor that can be easily stored, transported, assembled, and disassembled by a single user, or a small number of users. Particular desirable is a lightweight portable dance floor that is made of either rigid or flexible sections that can be either assembled and disassembled (dismantled) quickly by putting together separate pieces (as in the case of a modular configuration), or rolled up when not in use (as in the case of a configuration that is not necessarily modular), thus minimizing the space required to store the floor. Particularly desirable is a floor that is durable enough to withstand the continuous impact and weight of multiple people dancing on it, but also is light and portable enough to significantly reduce the effort it takes to deploy the dance floor for use, and store it after use.

### BRIEF SUMMARY

In certain embodiments, the present disclosure is directed to a portable dance floor comprising one or more removably couplable panels, the one or more removably couplable panels comprising (a) a base layer, (b) a top layer disposed over the base layer, and (c) a lighting element.

In certain embodiments, the base layer comprises (i) one or more channels extending in a downward direction from a top surface of the base layer, the one or more channels having a depth less than a thickness of the base layer, and (ii) one or more fasteners disposed on one or more surfaces of the base layer. In certain embodiments, the lighting element is disposed within the one or more channels of the base layer.

In certain embodiments, the one or more fasteners disposed on one or more surfaces of the base layer of a first removably couplable panel is configured to removably attach to one or more fasteners of a second removably couplable panel.

In certain embodiments, one or both of the base layer and the top layer of the removably couplable panels are comprised of a lightweight material that is flexible or rigid.

In certain embodiments, the lighting element is comprised of one or more light emitting diodes (LEDs).

In certain embodiments, the present disclosure is directed to a single layer portable modular dance floor comprising: (a) a first panel having a substantially flat top surface, a bottom surface facing opposite the top surface, and a perimeter edge, the bottom surface comprising a recessed area defined by the perimeter edge and an interior support wall extending downward from the top surface; the perimeter edge comprising one or more apertures; and (b) a lighting element disposed within the recessed area of the first panel.

In certain embodiments, the recessed area of the first panel includes a channel.

In certain embodiments, the lighting element comprises a wired connection disposed within the channel.

In certain embodiments, one or more of the apertures along the perimeter edge is configured to receive the wired connection of the lighting element, thereby extending the lighting element from the first panel to the second panel. In certain embodiments, a portable modular dance floor herein further comprises one or more fasteners configured to fit within the one or more apertures along the perimeter edge, and to releasably engage the one or more apertures with one or more corresponding apertures along a corresponding perimeter edge of a second panel to hold the first panel and the second panel adjacent to each other, and wherein one or more of the fasteners comprises a center portion having a hole therethrough, such that the fastener can simultaneously releasably connect the first panel and second panel, and permit the wired connection of the lighting element to pass through the hole.

In certain embodiments, one or more of the fasteners comprises a center portion having a hole therethrough, such that the fastener can simultaneously releasably connect the first panel and second panel, and permit the wired connection of the lighting element to pass through the hole.

In certain embodiments, at least one of the first panel or the second panel comprises a transparent or translucent material through which light emitted from the lighting element is visible through the substantially flat top surface.

In certain embodiments, the portable modular dance floor further comprises a top layer disposed over the substantially flat top surface.

In certain embodiments, the portable modular dance floor further comprises a base layer disposed under the bottom surface. In certain embodiments, one or both of the top layer and the base layer comprises anti-skid material.

In various embodiments, the top surface is sufficiently durable as to withstand at least 50 pounds per square foot (0.35 psi or 2.4 kPa) without the need for an additional top layer.

In certain embodiments, the present disclosure is directed to a method of assembling a portable modular floor comprising the first panel and second panel comprises the steps of (a) disposing the first panel on a substantially flat surface; and (b) fitting the one or more fasteners into the one or more apertures disposed along the perimeter edge of the first panel and the corresponding one or more apertures disposed along the perimeter edge of the second panel to assemble the portable modular floor; wherein the assembling is accomplished by fewer than three (3) individuals without the need for additional mechanical assistance.

In certain embodiments, the present disclosure is directed to a method of disassembling a portable modular floor comprising the first panel and second panel comprises the steps of (a) removing the one or more fasteners disposed along the perimeter edge of the first panel and connecting the first panel to the second panel, to separate the first and second panel from each other; (b) stacking the first panel and the second panel; and (c) transporting the stacked first panel and second panel to a different location; wherein the disassembling is accomplished by fewer than three (3) individuals without the need for additional mechanical assistance.

In certain embodiments, the present disclosure is directed to the improvement of combining the advantages of a surface layer and a base layer into a single layer, in a way that provides structural support, space and protection for a lighting element and possible electrical elements, and does away with the need for a base layer. This can further enhance the portability and lightness of a portable dance floor herein.

In certain embodiments, the present disclosure is directed to a portable dance floor comprising: (a) first and second panels having a substantially flat top surface, a bottom surface facing opposite the top surface, and a perimeter edge, the bottom surface comprising a recessed area defined by the perimeter edge and an interior support wall extending downward from the top surface; the perimeter edge comprising one or more apertures; the first and second panels configured adjacent to each other and connected along a portion of each of the first and second panel’s perimeter edges to form the portable dance floor; and (b) a lighting element disposed within the recessed area of the first panel.

In certain embodiments, the present disclosure is directed to a portable dance floor comprising:

(a) first and second panels having a substantially flat top surface, a bottom surface facing opposite the top surface, and a perimeter edge, the bottom surface comprising a recessed area defined by the perimeter edge and an interior support wall extending downward from the top surface; the perimeter edge comprising one or more apertures; the first and second panels configured adjacent to each other and connected along a portion of each of the first and second panel’s perimeter edges to form the portable modular dance floor; and (b) aa lighting element disposed within the recessed area of the first panel. In certain embodiments, the first and second panel’s perimeter edges can be connected to an electrical cord, a fastener, or a living hinge, to form the portable dance floor.

In certain embodiments, the present disclosure is directed to a portable dance floor comprising:

(a) a panel having a substantially flat top surface, a bottom surface facing opposite the top surface, and a perimeter edge, the bottom surface comprising a recessed area defined by the perimeter edge and an interior support wall extending downward from the top surface; and

(b) a lighting element disposed within the recessed area; wherein the lighting element is visible to the naked eye when viewed from above portable dance floor through the top surface of the portable dance floor.

### BRIEF DESCRIPTION OF THE DRAWINGS

Exemplary embodiments of the present disclosure will be described with references to the accompanying Figures, wherein:

FIG. 1A shows a floor and panels according to an embodiment herein. FIG. 1B shows the bottom of panel of a floor according to an embodiment herein.

FIG. 2 shows an exploded view of a panel according to an embodiment herein.

FIGS. 3A and 3B show side and top views of a panel according to an embodiment herein.

FIG. 4 shows a portable dance floor according to an embodiment herein, in a rolled up condition.

FIG. 5 shows a bottom-up view of a panel according to another embodiment herein.

FIG. 6 shows a floor according to an embodiment of a portable floor herein, including two panels connected to each other, viewed from underneath the portable floor.

FIG. 7 shows a fastener according to an embodiment herein.

FIG. 8 shows, in closer detail, the connection between panels according to a bottom-view of an embodiment herein.

FIG. 9 shows a side view of a portable dance floor in accordance with certain embodiments herein.

FIG. 10 shows a bottom-up view of a panel according to another embodiment herein.

FIG. 11 shows bottom-up view of a panel according to another embodiment herein, including lighting elements and an extension cord.

FIG. 12 shows a top view of a portable dance floor according to another embodiment herein, in use.

### DETAILED DESCRIPTION

The exemplary embodiments of the present disclosure can provide for, in various embodiments, a portable dance floor in general, or a portable modular dance floor more particularly. Exemplary embodiments of the various methods and apparatuses will now be described with reference to the Figures. The following description of the various embodiments is merely exemplary in nature and is in no way intended to limit the scope of the disclosure, its application, or uses.

As used herein, “portable” means capable of being transported by a single individual or a small group of individuals, without the need for specialized equipment or power either to put together, dismantle, or transport. For example, in certain embodiments, the lightweight portable dance floors herein can be set up and dismantled by a single person and easily transported from one point to another in a single trip. In other embodiments, a floor herein can be assembled or disassembled by fewer than three (3) individuals without the need for additional mechanical assistance. As used herein, “additional mechanical assistance” means mechanical tools and power tools typically used for installing or removing flooring such as hammers, saws, cutters, spacers, trowels, nailers, crowbars, scrapers, rollers, nailers, pins, nails, screws, adhesives, or the like. In certain embodiments, a floor herein can be easily assembled and disassembled at a location (either a storage location or a venue such as a wedding or party), in that one or a small group of individuals can roll or unroll the panels (either separate or together), or can assemble or disassemble the panels and then stack them for transport (either by carrying manually or by loading them into a vehicle) to another location.

As used herein, “lightweight” means weighing no more than can be easily carried by hand by an adult of average size, without the need for assistance by another individual or an item such as a wagon or lift. As used herein, “rigid” means being not easily deformed (as visible to the naked eye) upon the application of normal manual force by an adult of average size, without further mechanical assistance; “flexible” means the opposite (that is, visibly deformed to the naked eye).

Throughout the present disclosure, when described in sequential words (for example, using “then” or “next”), such description is not limiting to the described steps in the particular order set forth, but also includes embodiments wherein the steps are presented in any order. As used herein, the term “or” as used herein means any one or more of the alternatives, including all of the alternatives.

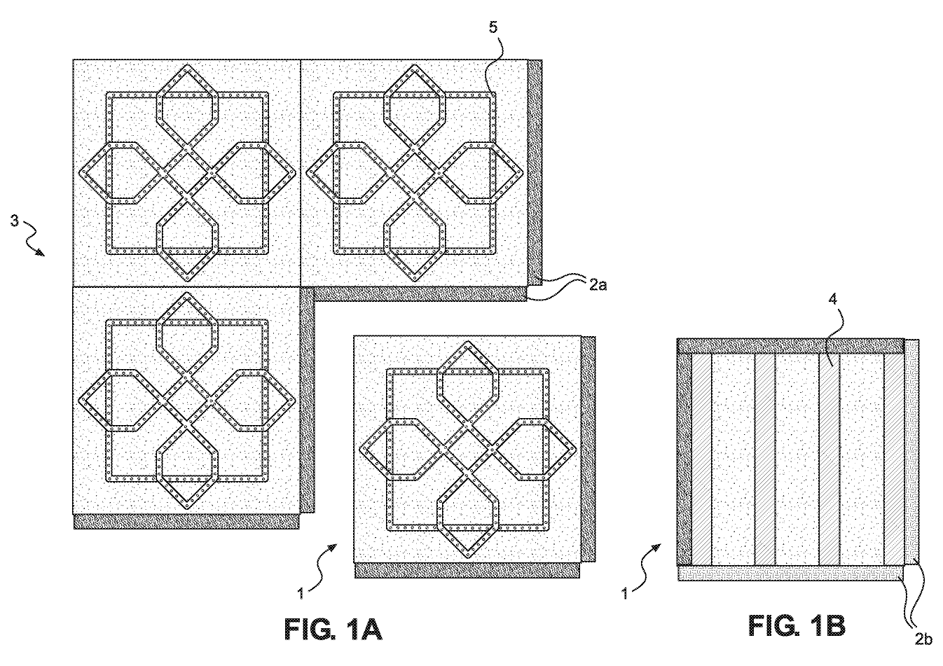

FIG. 1A illustrates a top view of a portable dance floor 3 according to an exemplary embodiment of the present disclosure. In various embodiments, the portable dance floor 3 herein comprises one or more removably couplable panels 1. As can be seen in the embodiment shown in FIG. 1A, a panel 1 can have a hook and loop fastener male side strip 2a along one or more edges. As shown in FIG. 1B, a panel 1 can also have a hook and loop fastener female side strip or edge 2b along one more edges, configured in such a way that adjacent panels 1 can be fastened together when in use. In various embodiments, the configuration of male edges 2a and female edges 2b can be in any pattern, and need not be shown specifically as in FIGS. 1A and 1B – that is, the male edges 2a are shown on the lower right of the panels and the female edges 2b on the lower left of the panels; however, the embodiments are not so limited, so far as the panels 3 are configured in a way that permits them to be removably attached together.

In certain embodiments as shown in FIG. 1A, the lighting element 5 is at least partially visible to the user upon looking down at the panel, either through a transparent or translucent interface. As shown further in FIG. 1B, in certain embodiments, a panel 1 herein can, as shown on its underside (opposite side of the side on which users can dance), comprise one or more portions (here, stripes) of an anti-skid or friction-inducing material 4. In various embodiments, this material can comprise rubber or a polymer, or material having a rough surface, such as sandpaper, and can serve to keep the dance floor 3 in place during use and avoid slippage of the dance floor 3. In other embodiments, the anti-skid material can be disposed on the top side of the panel to provide further safety and anti-slip characteristics to the side on which the users dance.

In various embodiments, the panels herein can be joined together or removed, as illustrated herein, to form a dance floor of a desirable dimension. The panels herein can have any desirable dimensions, for example, between 3 x 3 feet (0.9 x 0.9 meters) and or 5 x 5 feet (1.5 x 1.5 meters). The dimension of the dance floor herein can vary based upon the number of panels joined together—for example, a dance floor comprised of a plurality of 4 x 4 foot (1.2 x 1.2 meter) panels may form a 8 x 8 foot (2.4 x 2.4 meter), 12 x 12 foot (3.7 x 3.7 meter) or 16 x 16 foot (4.9 x 4.9 meter) dance floor. However, it should be noted that the panels herein need not be uniformly square or any particular shape, and can be configured in any manner that is desirable to the user.

In various embodiments, the thickness of a panel herein, or of a portable floor herein, can be 0.25 to 2 inches (0.6 to 5 centimeters), 0.3 to 1.5 inches (0.8 to 3.8 centimeters) or 0.5 to 1.5 inches (1.3 to 3.8 centimeters), or 0.4 to 2 inches (1 to 5 centimeters), or 0.5 to 2.5 inches (1.3 to 6.5 centimeters).

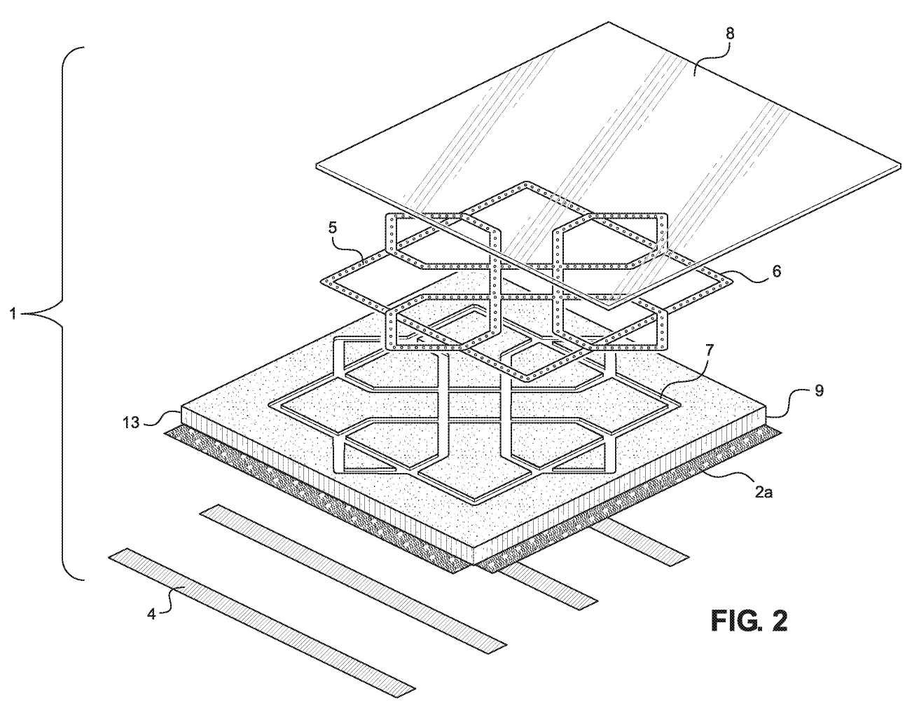

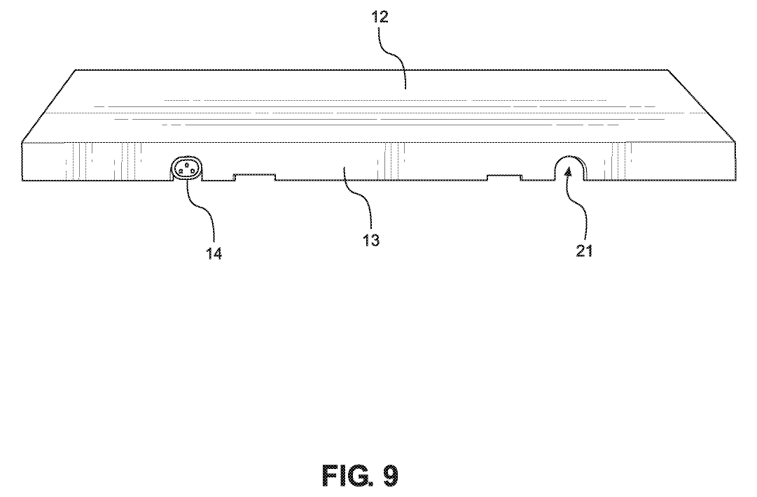

FIG. 2 illustrates an exploded view of one of the plurality of panels 1 of a portable dance floor 3 herein. In various embodiments, a panel herein can comprise a base layer 9 and a top layer 8, with a perimeter edge 13 marking the thickness of the base layer. In various embodiments, one or more of the panels 1 herein can comprise a lighting element 5, including but not limited to a light emitting diode (“LED”), either a single one, or an LED strip (also referred to as ribbon LEDs or rope lights), for example, flexible strip lights which eliminate the need for a circuit board. In various embodiments, the lighting element 5 disclosed herein can include one or more of the following features: changing the color of the light emitted; adjusting the brightness of the light emitted; flashing the light emitted in a pattern, or synchronizing the light emitted to the rhythm of sound or music with a sensitivity adjustable microphone. As shown in FIG. 2, the lighting elements 5 can be configured in the form of a light cable 6. In other embodiments, for example, as shown in FIGS. 9 through 11, a light strip here is connected to an electrical cord and through that, to a power source – for example, a wall outlet, or a portable power source such as a battery, power bank, or generator.

In certain embodiments, the base layer 9 of one or more panels herein can comprise one or more channels 7 that extend downward from a top surface of the base layer in a direction of a thickness of the base layer. In such embodiments, the lighting element 5 of a panel can be disposed within the one or more channels 7 herein. In various embodiments, the depth of a channel 7 can be less than the thickness of the base layer 9, such that the channel does not extend entirely through the base layer but is able to accommodate the dimensions of the selected lighting element. The channels can form any pattern that is desirable to a manufacturer or user. I other embodiments, a channel is on the underside of the base layer and extends upward, such that any light element disposed therein can be at least partly visible when viewing the panel from the top down.

In certain embodiments, a top layer 8 is disposed over, and substantially covers, the base layer of a panel herein, such that a lighting element 5 disposed within a channel 7 of the base layer is enclosed within the panel 1. In various embodiments, at least a portion of the top layer 8 is transparent or translucent to permit light emitted from the lighting element to pass through it; or alternatively, it can be opaque in various portions. As used herein, “transparent” means allowing light to pass through without appreciable scattering, such that objects on the other side can be seen substantially clearly to the naked eye, as with material that has a single index of refraction. As used herein, “translucent” means allowing light to pass through with scattering, such that objects on the other side are visible but cannot be seen substantially clearly to the naked eye, as with material having different indices of refraction (in certain embodiments, a ”frosted” effect). As used herein, “opaque” means not allowing light to pass through as discernible to the naked eye. The same can be said for any embodiment herein that comprises a single layer panel or dance floor; the definitions of “translucent” or “transparent” or opaque just apply to the characteristics of a single layer.

In various embodiments, the top layer is attached to the base layer with, for example, an adhesive, magnets, snaps, or hook and loop fastener strips (e.g., Velcro®).

In various embodiments, the base layer 9 of a panel herein can further comprise one or more fasteners to removably attach one or more other removably couplable panels. It is to be understood that any fastener, or combination of fasteners, that can releasably couple adjacent panels can be used, including but not limited to hook and loop strips (e.g., snap and hood fasteners such as Velcro®), magnets, snaps, or the like. In certain embodiments, the one or more fasteners can be disposed on one or more surfaces of the base layer, including but not limited to the bottom surface or the edges of the base layer. For example, as shown in FIGS. 1A-1B, in certain embodiments hook and loop strips (e.g., Velcro®) 2a (male) and 2b (female) can be disposed along any portion of the perimeter of the bottom surface of the base layer.

In various embodiments, rubber or similar friction-inducing material 4 can be disposed on a portion of the top surface of the top layer 8 or the bottom surface of the base layer 9 of a panel herein to provide anti-skid properties.

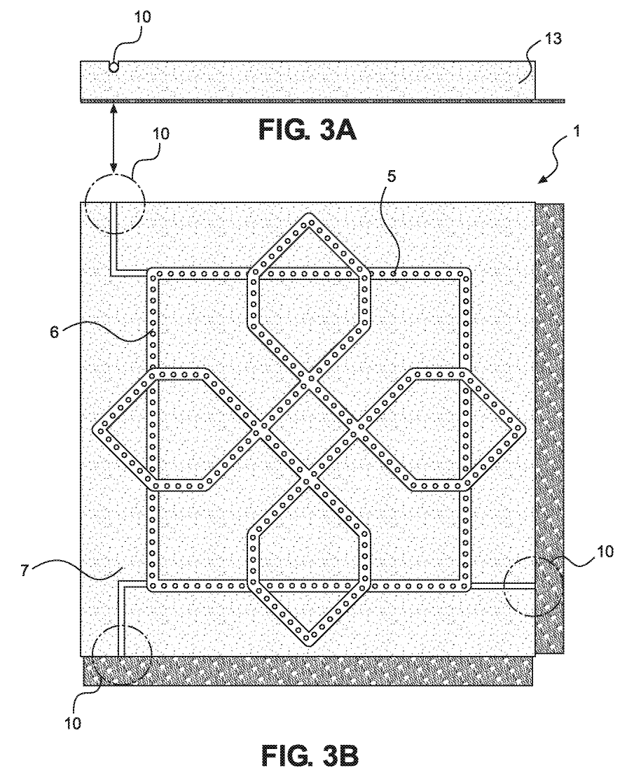

In various embodiments, for example as shown in FIG. 3B, a channel 7 of the base layer 9 of one or more panels 1 herein can extend to the edge of the perimeter of the base layer 9. Such channels 7 can allow a wired connection of the lighting element 5, such as a light cable 6, to extend out of the base layer to permit, for example, connection of the lighting element to an external power supply unit (e.g., USB adapter, AC adapter), a lighting element of an adjoining panel, or a remote-control receiver to permit a user to control the lighting element with a remote-control transmitter.

As shown further in FIG. 3A and FIG. 3B, in certain embodiments, a panel can include a plug placement 10 that permits assembly of multiple panels by joining multiple light cables 6 across such multiple panels, to create an overall pleasing pattern of lighting. FIG. 3A shows the cross-section of such a configuration, wherein the plug placement 10 acts as a connector between two panels.

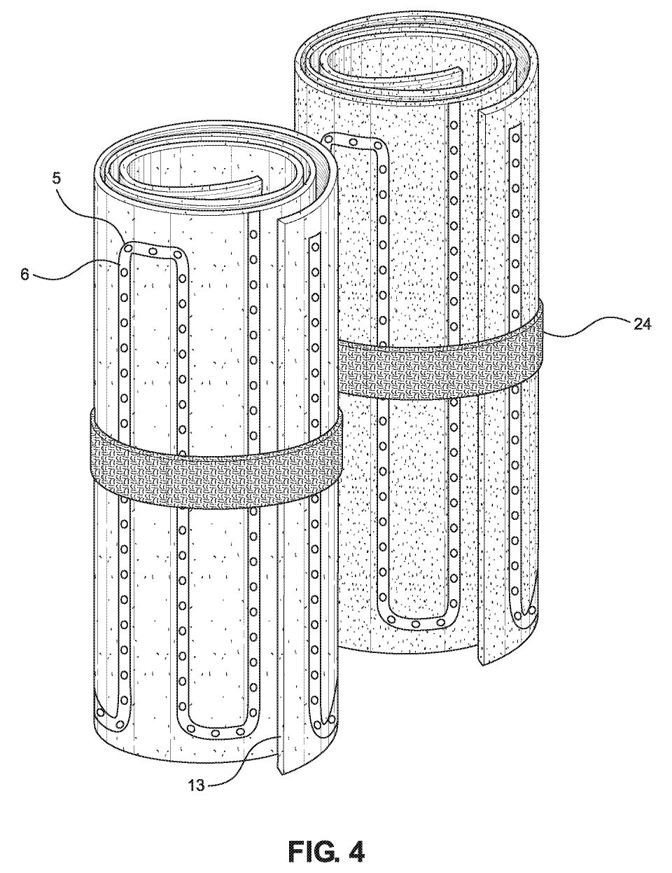

In certain embodiments, one or both of the base layer 9 and the top layer 8, or any part of a panel or portable floor herein (whether a single layer or multiple layers) can comprise any lightweight material, including but not limited to any polymer such as Polypropylene, Poly Etheline, ABS, polyamide, acrylic, or polystyrene (including, e.g., high-density closed cell polyethylene foam). In certain embodiments, such material is lightweight, flexible, rigid, or durable. For example, in various embodiments, any part of a panel or portable dance floor herein is flexible and can be rolled up; or alternatively, is sufficiently rigid to lie flat while in use and also not be capable of being rolled up, but rather, can be stacked or folded for transport or storage. Various advantages can be provided by the use of such materials, including but not limited to, providing panels able to withstand the weight and impact of multiple adults for extended periods of time, while permitting the portability of the panels comprising the dance floor. Moreover, in reference to the embodiments shown in FIG. 4, a top layer and bottom layer comprised of such material, whether flexible or rigid, can further permit a user to stack the panels upon themselves, or roll them up, for additional portability and easy storage when the dance floor is not in use. FIG. 4 shows a rolled-up floor in accordance with certain embodiments herein, when not in use. As can be seen therein, one advantage of the technology herein is that it provides for easy assembly, disassembly and storage of a floor herein. In certain embodiments, a floor herein can comprise just a single panel that can be rolled up easily for transport and storage, or alternatively, multiple panels that can be separated from each other and each individually rolled up for transport and easy storage, or stacked together; or still alternatively, multiple panels that cannot be rolled up, but rather are sufficiently rigid that they must be stacked together. In the embodiment shown in FIG. 4, the lighting elements 5, which as shown here are in the form of a light cable 6, can be removed from the channels in which they are held, or alternatively can be left in the channels during storage and transport. Further, in certain embodiments, a band 24 can be used to hold together a rolled up panel or floor for transport and storage, but when removed, will not deform the panel or floor, so that it lies flat for easy use.

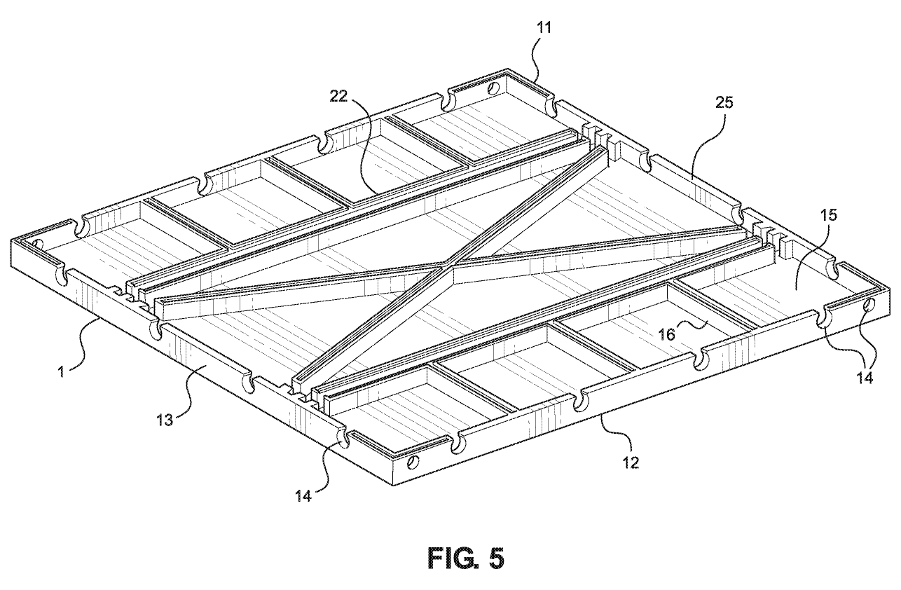

While the discussion above is directed to embodiments comprising both a base layer and a top layer, it is important to note that in certain embodiments, a portable dance floor herein does not require any such separate layers, and rather, can comprise only a single layer – that is, one layer and no more. For example, as seen in embodiments shown in FIGS. 5 through 11, in certain embodiments, the technology herein is in the form of a single layer dance floor, which can be an integrated dance floor wherein the top layer and bottom layer together comprise one layer that can function with the advantages of both. This can permit the dance floor to be thing yet strong, and truly portable. In certain embodiments, for example, as shown in FIGS. 9 through 12, such panels are rigid and can be folded or stacked for transportation or storage, and cannot be rolled.

In exemplary embodiments, FIGS. 5 through 8 illustrate a portable modular floor comprising a single layer, and having a first panel 1 having, among other features, a bottom surface comprising a recessed area. In particular, FIG. 5 shows another embodiment of a panel as described herein, shown with the bottom surface 11 facing upward to demonstrate the recessed portions, and the top surface 12 facing downward, all for ease of reference and illustration of the embodiment shown.

As can be seen in FIG. 5, in certain embodiments the top surface 12 is the surface that users will contact with their feet while dancing, and the bottom surface 11 is the surface that contacts the ground when the modular floor is in use. In the embodiment shown here, the perimeter edge 13 further includes one or more apertures 14. The recessed area 15 defined by both the perimeter edge 13, and an interior wall 16 that extends downward from the top surface 12. In various embodiments, the recessed area includes a channel; or itself defines a channel.

Further, in certain embodiments, one or more channels 22 are present in the underside of the panel 1, and also extend downward from the top surface, as do the perimeter edge 13 and the interior wall 16.

In certain embodiments, the channels can enclose one or more lighting elements 5. In FIG. 5, such lighting elements may not be visible, as they could be, in certain embodiments, enclosed within the channels or so deep within the recesses of the channels that they cannot be seen readily from the underside of the panel.

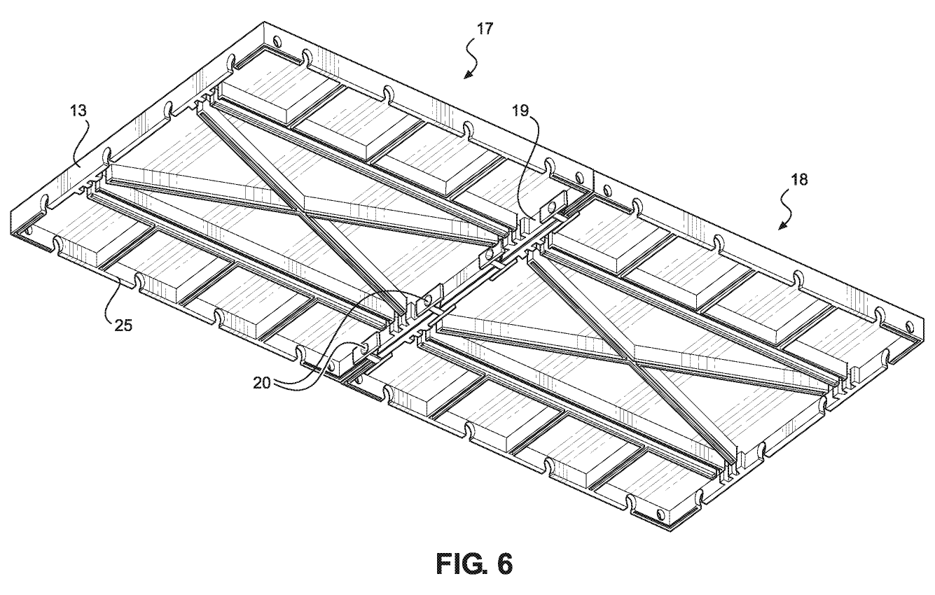

FIG. 6 shows another embodiment of a modular floor as described herein, with a first panel 17 connected to a second panel 18. For ease of reference, FIG. 6 shows a view of a floor herein from beneath the floor, looking up to its bottom surface.

In certain embodiments, the first panel 17 and second panel 18 contact each other through a connected surface 19. In certain embodiments, the connected surface comprises a hinge, such as, for example, a removable hinge (which can be separated from the two panels during disassembly of the modular floor), or a living hinge. As used herein, “living hinge” means a thin, flexible section of material that connects two parts made of the same material, allowing them to bend, fold, and rotate. In certain embodiments, if a living hinge is present in a floor herein, assembly and disassembly can be easily performed by folding up the floor along one or more living hinges, instead of (or in addition to) separating the panels from each other to stack or roll.

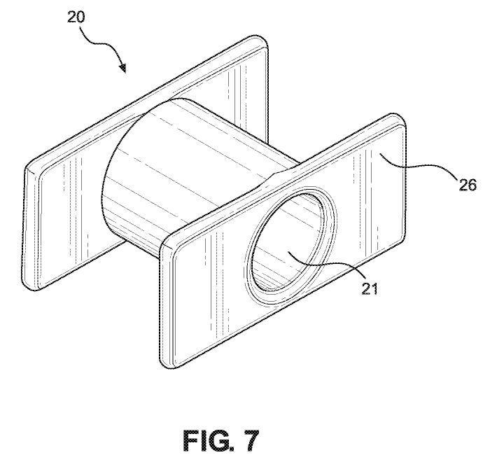

In other embodiments, the first panel 17 and second panel 18 are connected to each other releasably, through one or more fasteners 20. FIG. 7 shows a close-up of a fastener 20, which has a hole 21 through which a wired connection 6 of a lighting element 5 can pass, thereby extending the lighting element from the first panel to the second panel. The hole 21 an, in other embodiments, be useful to allow any other item to pass that may further contribute to the desirability of a floor herein, including a sound cable or any other device or mechanism. In the embodiment shown in FIG. 7, the fastener 20 also contains winged portions 26 that protrude from the fastener and serve to engage the interior of the panel by holding it in place when they contact the interior of the perimeter edge 13. In certain embodiments, the presence of the hole 21 means that the fastener 20 can simultaneously releasably connect the first panel 17 and the second panel 18, and also permit the wired connection of the lighting element to pass through the hole, allowing for a seamless lighting experience across multiple panels of the floor.

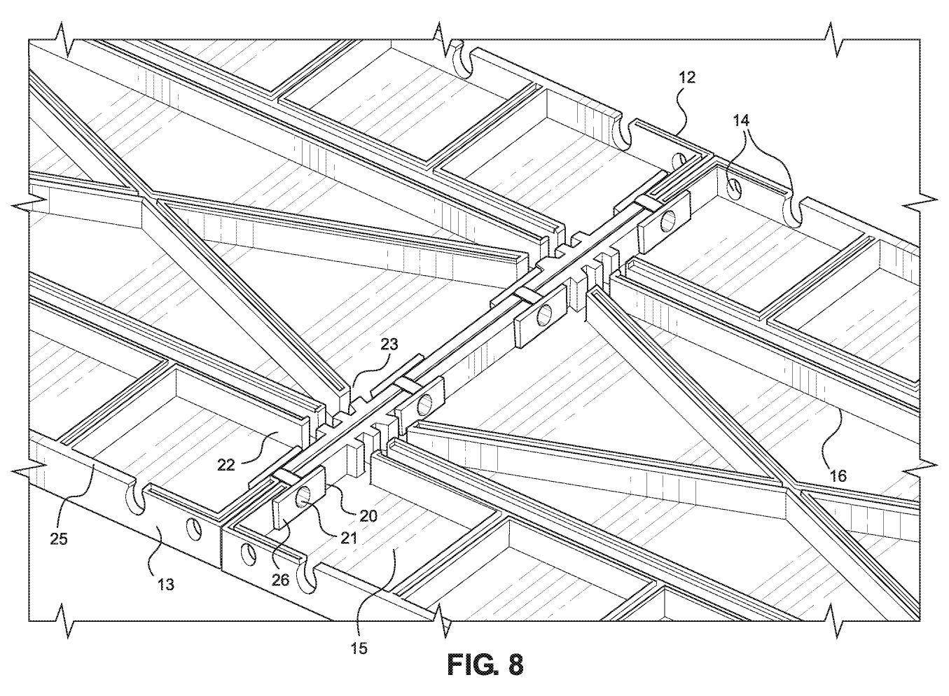

FIG. 8 shows a further close-up of the releasable connection portion between the first panel and second panel in certain embodiments; demonstrating how the fastener 20, with its hole 21, can be releasably used to attach the two panels. When inserted into an aperture 14, the winged portions 26 can engage the interior of the perimeter edge, in such a manner that the hold is sufficient to withstand the impacts from dancing, but can be easily separated by ordinary manual force – that is, the application of human hands without the assistance of further mechanical force such as that provided by tools.

FIGS. 9 through 12 illustrate further embodiments of a single-layer portable dance floor herein – that is, a portable dance floor comprising one or more panels (that is, whether a single panel alone, or along side an adjacent panel) made of only a single layer of material having a top surface 12 and a bottom surface 11, and no additional layers. All descriptions and embodiments in the present disclosure referring to characteristics of any part of a multi layer panel or dance floor described herein, also can, in various embodiments, refer to the characteristics of a single layer panel or dance floor herein.

In certain embodiments, each or both of the top surface or bottom surface of any part of a multi-layer panel or dance floor herein, or a single layer dance floor herein, are substantially or entirely flat. In various embodiments, the recessed area 11 is defined at least in part by the perimeter edge, but any portion of the recessed area can also be defined by one or more channels in the interior of the bottom surface of the panel.

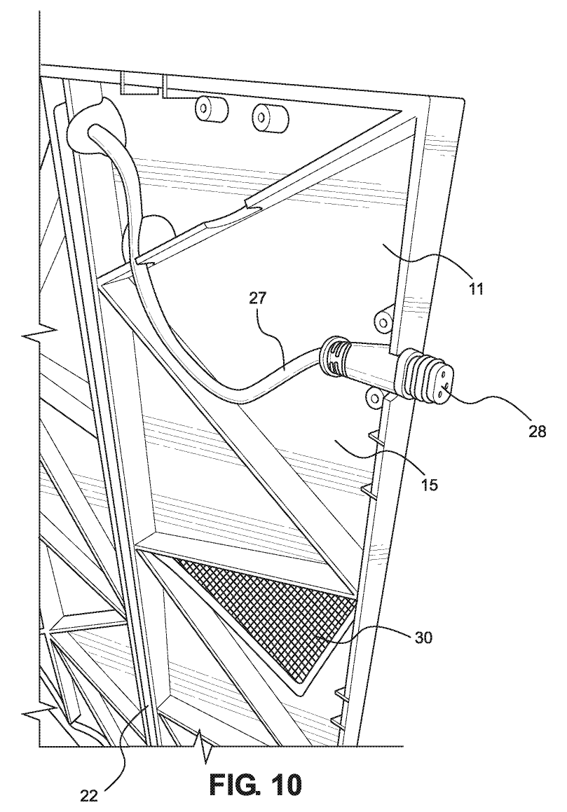

In certain embodiments, in such a single layer configuration, the only item, or substantially the only item, touching the ground during use is the portion 25 of the perimeter edge 13, for example, as shown in FIG. 5. As seen in FIG. 9, a side view of a dance floor in accordance with such embodiments shows that it such dance floor can be desirably thin, yet strong and rigid, measuring, in certain embodiments, 0.2 to 1.5 inches (0.5 to 3.8 cm), 0.3 to 1 inch (0.9 to 2.5 cm), or 0.4 to 0.8 inches (1 to 2 cm) in height. FIG. 9 illustrates an embodiment in which an aperture 14 is on the perimeter edge 13 of the panel, with the top surface 12 the part on which a user can dance. In the embodiment shown in FIG. 9 and FIG. 10, a cable 27 can be placed along the recessed area 15 on the underside of the top surface of the pane, for example, along the recessed area on the underside of the top surface of the panel. This cable can be configured to connect the lighting element to an electrical power source. In the embodiment shown in FIG. 10, the cable 27 terminates in a connector 28, for example, a 3-pin connector that can connect to a corresponding connector on an adjacent cable, e.g., via male and female connection points that can, in various embodiments, connect via pushing or threading. In such embodiments, such male and female connection points qualify as “fasteners” in accordance with the present technology; in other embodiments, such male and female connection points do not fasten the panels together, but rather, just fasten one electrical cable to another. In certain embodiments, a modular dance floor herein can be configured with one or more panels as discussed herein, with a male or female connector as a fastener, and alternatively, additional fasteners as further contemplated herein, or with no fasteners at all connecting any portion (including any panels) of a modular dance floor herein. In other embodiments, a dance floor herein can be in the form of a single panel only, and in such a case, the cable may not connect to any other panels, but may just be configured to deliver the desired electrical power to the lighting element.

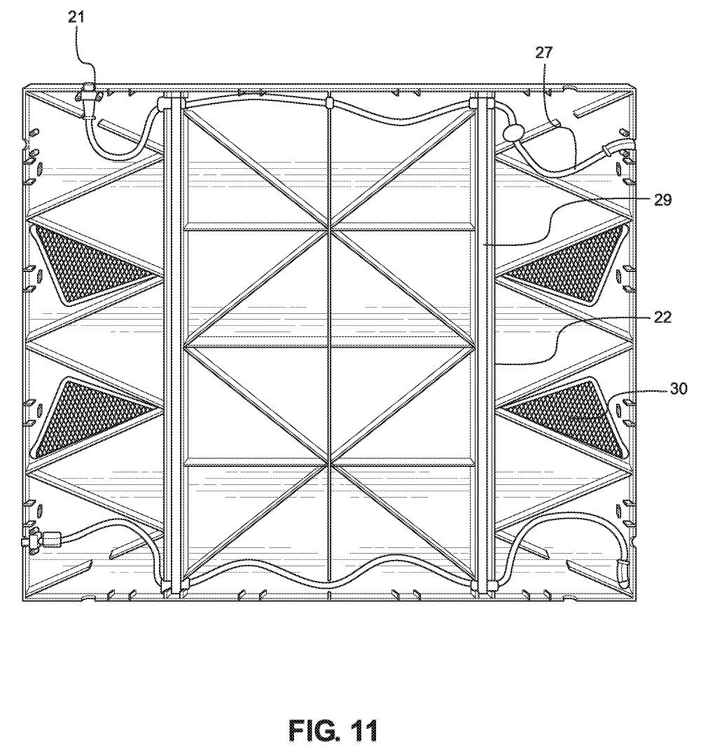

Referring to FIGS. 8, 10 and 11, in certain embodiments, the lighting element 5 can be contained within one or more channels 22, but it is important to note that there is no limitation on where the lighting element can be disposed within the bottom surface of a panel. In various embodiments, for example as shown in FIG. 11, the lighting element is disposed within a channel in the recessed area, the channel comprising two interior support walls extending downward from the top surface. For example, a lighting element can be disposed in a space 23 on the end of a channel 22; for example, a wired connection 6 can be held within that space, and its end can be strung through the hole 21 of a fastener to proceed within an adjacent panel. In other embodiments, a lighting element can be contained partly or entirely within any recessed area 15 on the underside of the top surface of the panel, as may be desired by the user, e.g., for visual effect or further stability.

For example, as seen in FIGS. 10 and 11, a lighting element 5 can comprise one or more strips of lights lying within channels 22 and being powered by the cord 27. In certain embodiments, the strips of lights can be further reinforced in strength by a metal cover that lies atop the open surface of the channel, providing further stability with the dance floor is in contact with the ground or floor surface. In certain embodiments, a lighting element 5 can comprise one or more strips of lights that are attached directly to the bottom surface 11 of the panel. For example, the lighting element can be glued, pasted, magnetically attached, attached with a hook and loop fastener, or otherwise permanently or removably attached to the bottom surface 11 of the panel – that is, the underside of the panel.

In various embodiments, the lights and any supporting structure will not be in physical contact with the ground when the floor is in use – that is, the lighting element can be attached to the bottom surface of the portable dance floor and does not touch the ground underneath the dance floor. This can be advantageous in preventing damage to any electrical components from spilled liquids or the like while the floor is in use. In other embodiments, the lights or any supporting structure can touch the ground in whole or part, to provide further stability.

In certain embodiments, any part of the underside of a dance floor herein can further include one or more grips 30 or any anti-skid or friction-inducing material to provide further stability and friction, avoiding slipping with the ground or floor surface. These can include, for example, natural or synthetic rubber, cork, sand, gravel, polyvinyl chloride (PVC), polyurethane, or other abrasive materials such as aluminum oxide and silicon carbide. In various embodiments, these are located on the portion 25 of the perimeter edge 13 that contacts the ground (or any surface below the panels), or on any portion of the underside of the dance floor that touches the ground, or does not touch the ground.

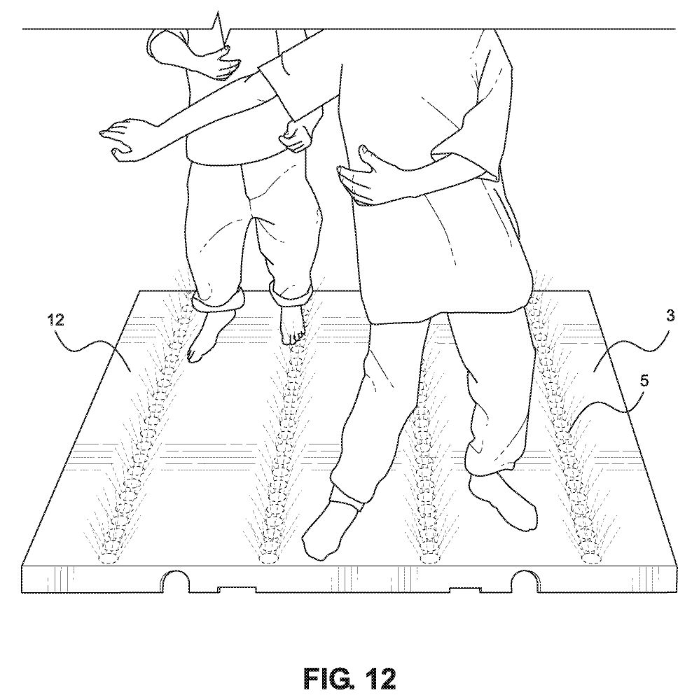

As shown in FIG. 12, in certain embodiments of a single layer portable dance floor as discussed herein, when in use, one or more of the lighting elements 5 even though present on the underside of the portable dance floor, can be visible to the naked eye (that is, without any enhancements or assistance) when viewed from above portable dance floor through the top surface 12 of the portable dance floor 3; or put another way, can be visible when viewed from above the portable dance floor, shining through from the underside of the flat area of the single layer panel. This can provide a visually pleasing effect for users. It also avoids the inconvenience of having lighting elements on the top surface of the dance floor or embedded therein, which may interfere with users’ ability to dance on the top surface. In this manner, because the lighting elements are underneath but still visible from the top, a higher degree of safety for the dancers can be ensured, as any tripping risk can be avoided.

Thus, in certain embodiments, a panel herein comprises a single layer of material with no breaks in it for any other element that is not the panel itself, such that any lighting element that may be present is fully on the underside of the single layer of material, and does not extend upward far enough to be flush with the top layer of the panel. That is, in such embodiments, the substantially flat top surface comprises a single layer of only a single material across its entirety, with no breaks either in the interior of the flat top surface, or anywhere else – e.g., no breaks or different material along any edge of such surface.

In certain embodiments, the single layer panel configuration avoids the need to have separate elements of the panel to serve specific functions, such as providing a smooth surface to dance on; protecting the lights and cables from damage; providing strength to withstand the rigors of being danced on; and having a base layer to further house the lights and electronics and further protect them from impact and from liquid on the ground. All of this can be done, in certain embodiments herein, via the single structure which makes up the single-layer panel. The outcome of using this single-layer panel design is that it can create an LED dance floor that is uniquely light and compact enough to function as a portable household item.

In certain embodiments, a panel or dance floor herein can be fully operational without the need for any securing mechanisms to stabilize it to the ground – that is, in its simplest form, it can merely be taken out of storage and put directly on the ground, and is stable enough such that no adhesives, pins, underlayments (e.g., mats or rugs) are necessary to secure it to the floor for use.

In certain embodiments, a portable dance floor herein can include a control system that permits a user to provide a pattern of lighting (for example, pre-programmed, set on a timer, or adapted to turn on and off with a music beat or other pattern, further enhancing the user’s experience when dancing.

In certain embodiments, a portable floor herein comprises one or more panels connected together, without the need for any additional layers – that is, in various embodiments, no top surface, or no bottom surface to engage the ground. In such embodiments, the top surface of the panels can be durable enough to withstand multiple blows by the feet of dancers without the need for any additional layers of material. In other embodiments, the bottom surface of the panels may itself be made of material that is anti-slip enough to withstand slippage of the panels on the ground during use, without the need for any further anti-slip material or layer. Further, referring to FIGS. 6 and 8, in certain embodiments, the portion 25 of the perimeter edge 13 that contacts the ground (or any surface below the panels) can be made of anti-skid material, or covered partly or fully with anti-skid material, or can be coated with any such materials – for example, in the form of a strip on the edge.

In various embodiments, a single panel herein weighs less than 1 kilogram (2.2 pounds), less than 2 kilograms (4.4 pounds), less than 5 kilograms (11 pounds), less than 4 kilograms (8.8 pounds), less than 3 kilograms (6.6 pounds), or 2 to 3 kilograms (4.4 to 6.6 pounds). In various embodiments, the sum of the weight of all panels in the portable modular floor is less than 100 kilograms (220 pounds), less than 90 kilograms (198 pounds), less than 80 kilograms (176 pounds), less than 70 kilograms (154 pounds), less than 60 kilograms (132 pounds, less than 50 kilograms (110 pounds), less than 40 kilograms (88 pounds), less than 20 kilograms (44 pounds), less than 10 kilograms (22 pounds), or less than 5 kilograms (11 pounds).

In various embodiments, a panel or floor herein, or the top surface of a panel or a portable floor herein, is sufficiently durable as to withstand a pressure of at least 50 pounds per square foot (0.35 psi or 2.4 kPa), or at least 75 pounds per square foot (0.52 psi or 3.6 kPa), or at least 100 pounds per square foot (0.70 psi or 4.8 kPa), with or without the need for an additional top layer. As these are units of pressure, and Pressure = force divided by area, the force that a panel or floor herein can withstand, can be calculated based on the total area of the dance floor.

### Impacts on Dance Floor

In other embodiments, a panel or floor herein exhibits superior resistance to impact, and also has the advantage of staying in place without shifting over long periods of time in active use, e.g., the length of a party, wedding or other event (for example, up to 24 hours, up to 18 hours, up to 12 hours or up to 6 hours). In various embodiments, when measuring the amount of pressure or force a panel or floor herein can withstand, these values can be measured based on a sustained impact of 30 seconds or 60 seconds, or intermittent impact over a period of 2 hours, 4 hours, 6 hours, or 12 hours.

In an exemplary embodiment, a panel herein has the following features:

Surface and back materials: PA

Voltage: AC 90 to 240V, 50/60Hz

Power: Maximum 4W

Light source: 5050RGB chip

Number of lamp beads :20 to 30 / piece

Color: RGB full color

Control: music controller

Life:≥ 50,000 hours

Power supply: 5 to 10V USB

Weight: about 2.5 to 3 kg

Size: L 60 to 70 cm x W 60 to 70 cm x H 1 to 5 cm

As mentioned herein, the present technology exhibits numerous advantages over known dance floor technologies. Among them are the fact that the portable dance floors discussed herein are uniquely configured to be portable household items, that can be used not just at parties, but also in homes for recreational and leisure activities. This makes such items different from other known dance floors, even those with lighting elements.

Although the present technology has been described in relation to embodiments thereof, these embodiments and examples are merely exemplary and not intended to be limiting. Many other variations and modifications and other uses will become apparent to those skilled in the art. The present technology should, therefore, not be limited by the specific disclosure herein, and can be embodied in other forms not explicitly described here, without departing from the spirit thereof.

We claim:

1. A single layer portable modular dance floor comprising:
(a) a first panel having a substantially flat top surface, a bottom surface facing opposite the top surface, and a perimeter edge, the bottom surface comprising a recessed area defined by the perimeter edge and an interior support wall extending downward from the top surface; the perimeter edge comprising one or more apertures; and
(b) a lighting element disposed within the recessed area of the first panel.

2. The portable modular dance floor of claim 1, wherein the recessed area of the first panel includes a channel.

3. The portable modular dance floor of claim 2, wherein the lighting element comprises a wired connection disposed within the channel.

4. The portable modular dance floor of claim 3, wherein one or more of the apertures along the perimeter edge is configured to receive the wired connection of the lighting element, thereby extending the lighting element from the first panel to a second panel.

5. The portable modular dance floor of claim 4, further comprising one or more fasteners configured to fit within the one or more apertures along the perimeter edge, and to releasably engage the one or more apertures with one or more corresponding apertures along a corresponding perimeter edge of a second panel to hold the first panel and the second panel adjacent to each other, and wherein one or more of the fasteners comprises a center portion having a hole therethrough, such that the fastener can simultaneously releasably connect the first panel and the second panel, and permit the wired connection of the lighting element to pass through the hole.

6. The portable modular dance floor of claim 1, wherein at least one of the first panel or the second panel comprises a transparent or translucent material through which light emitted from the lighting element is visible through the substantially flat top surface.

7. The portable modular dance floor of claim 1, further comprising anti-skid material.

8. The portable modular dance floor of claim 1, wherein the top surface is sufficiently durable as to withstand at least 50 pounds per square foot (0.35 psi or 2.4 kPa) without the need for an additional top layer.

9. The portable modular dance floor of claim 1, wherein the sum of the weight of all panels in the portable modular floor is less than 100 kilograms (220 pounds).

10. A portable dance floor comprising:
(a) first and second panels having a substantially flat top surface, a bottom surface facing opposite the top surface, and a perimeter edge, the bottom surface comprising a recessed area defined by the perimeter edge and an interior support wall extending downward from the top surface; the perimeter edge comprising one or more apertures; the first and second panels configured adjacent to each other and connected along a portion of each of the first and second panel’s perimeter edges to form the portable dance floor; and
(b) a lighting element disposed within the recessed area of the first panel.

11. The portable dance floor of claim 10, wherein the first and second panel’s perimeter edges are connected by an electrical cord, a fastener, or a living hinge, to form the portable dance floor.

12. A portable dance floor comprising:
(a) a panel having a substantially flat top surface, a bottom surface facing opposite the top surface, and a perimeter edge, the bottom surface comprising a recessed area defined by the perimeter edge and an interior support wall extending downward from the top surface; and
(b) a lighting element disposed within the recessed area,
wherein the lighting element is visible to the naked eye when viewed from above the portable dance floor through the top surface of the portable dance floor.

13. The portable dance floor of claim 12, wherein the lighting element is attached to the bottom surface of the portable dance floor and does not touch the ground underneath the dance floor.

14. The portable dance floor of claim 12, wherein the lighting element is disposed within a channel in the recessed area, the channel comprising two interior support walls extending downward from the top surface.

15. The portable dance floor of claim 12, further comprising a cable placed along the recessed area on the underside of the top surface of the panel, the cable configured to connect the lighting element to an electrical power source.

16. The portable dance floor of claim 12, wherein the substantially flat top surface comprises a single layer of only a single material across its entirety, with no breaks.
